(19) United States
(12) Patent Application Publication
(10) Pub. No.: US 2007/0257476 A1
(43) Pub. Date: Nov. 8, 2007

(54) Inflator with improved rupture disk support

(75) Inventors: Lloyd Green JR., Mesa, AZ (US); William B. Butler, Mesa, AZ (US); John P. O'Loughlin, Gilbert, AZ (US); Halley O. Stevens, Mesa, AZ (US); Katherine Desimone, Gilbert, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/415,685

(22) Filed: May 2, 2006

(51) Int. Cl. B60R 21/26

(52) U.S. Cl. 280/737; 280/740; 280/741

(57) ABSTRACT

An inflator (40) includes a chamber (220) for storing inflation (222) fluid under pressure. A first member (82) has an inner perimeter that defines an opening (92) for discharging the inflation fluid (222). A rupturable closure member (100) extends across the opening (92) and blocks inflation fluid flow though the opening. A second member (110) supports a central portion (302) of the closure member (100) against the pressure of the inflation fluid (222) in the chamber (220). Inflation fluid (222) flows through a passageway (270) defined by an outer perimeter of the second member (110) and the inner perimeter of the first member (82). An initiator (152) ruptures the closure member (100), forming petals (254) of the closure member that deflect into the passageway (270). The petals (254) slide along an outer surface (258) of a portion (132) of the second member (110) while deflecting into the passageway (270). The portion (132) of the second member (110) is configured not to inhibit movement of the petals (254) into full engagement with an inner surface (260) the first member (82).

### TECHNICAL FIELD

The present invention relates to an inflator for inflating an inflatable vehicle occupant protection device.

### BACKGROUND OF THE INVENTION

It is known to provide an inflator for inflating an inflatable vehicle occupant protection device. Examples of known inflator configurations include stored gas inflators, heated gas inflators, augmented inflators, hybrid inflators, and pyrotechnic inflators. These inflator configurations may include a rupturable closure member, such as a burst disk or rupture disk, that is rupturable upon actuation of the inflator to permit inflation fluid flow through an outlet of the inflator.

### SUMMARY OF THE INVENTION

The present invention relates to an inflator for inflating an inflatable vehicle occupant protection device. The inflator includes a chamber for storing inflation fluid under pressure. A first member has an inner perimeter that defines an opening for discharging the inflation fluid. A rupturable closure member extends across the opening and blocks inflation fluid flow though the opening. A second member supports a central portion of the closure member against the pressure of the inflation fluid in the chamber. Inflation fluid flows through a passageway defined by an outer perimeter of the second member and the inner perimeter of the first member. An initiator ruptures the closure member, forming petals of the closure member that deflect into the passageway. The petals slide along an outer surface of a portion of the second member while deflecting into the passageway. The portion of the second member is configured not to inhibit movement of the petals into full engagement with an inner surface of the first member.

The present invention also relates to an inflator for inflating an inflatable vehicle occupant protection device. The inflator includes a chamber for storing inflation fluid under pressure. A first member defines an opening for discharging the inflation fluid. A rupturable closure member extends across the opening and blocks inflation fluid flow though the opening. A second member supports a central portion of the rupturable closure member against the pressure of the inflation fluid in the chamber. The rupturable closure member engages terminal end portions of the first and second members and is curved in cross section due to the fluid under pressure. The terminal end portions of the first and second members have curved configurations to avoid stress risers in the rupturable closure member.

The present invention further relates to an inflator for inflating an inflatable vehicle occupant protection device. The inflator includes structure defining a chamber for storing a volume of inflation fluid under pressure. The chamber comprises an opening for discharging said inflation fluid. A rupturable closure member blocks inflation fluid flow through the opening. A support supports the closure member against the pressure of inflation fluid in the chamber. The support includes a terminal end portion engaging the closure member. The terminal end portion has a central opening across which the closure member extends. The support also includes a frusto-conical side wall terminating with the end portion.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates an apparatus for helping to protect an occupant of a vehicle, according to a first embodiment of the present invention;

FIG. 2 is a sectional view of an inflator of the apparatus of FIG. 1;

FIG. 3 is an enlarged view of a portion of the inflator of FIG. 2;

FIG. 4 illustrates a closure member of the inflator of FIGS. 2 and 3;

FIG. 5 illustrates certain dimensions of the inflator of FIGS. 2 and 3;

FIG. 6 is a chart illustrating certain characteristics of the inflator; and

FIG. 7 illustrates an apparatus for helping to protect an occupant of a vehicle, according to a second embodiment of the present invention.

### DESCRIPTION OF EMBODIMENTS

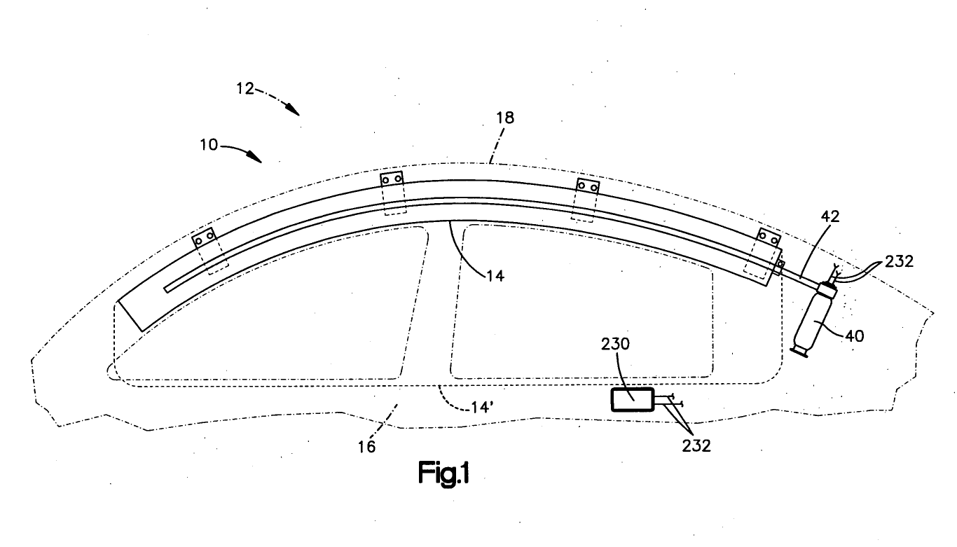

Representative of the present invention, an apparatus 10 helps to protect an occupant (not shown) of a vehicle 12. In the embodiment illustrated in FIG. 1, the apparatus 10 includes an inflatable vehicle occupant protection device in the form of an inflatable curtain 14. The apparatus 10 could include an alternative type of inflatable vehicle occupant protection device, such as an inflatable air bag, an inflatable seat belt, an inflatable knee bolster, an inflatable headliner, or a knee bolster operated by an inflatable air bag.

The inflatable curtain 14 has a stored position adjacent the intersection of a side structure 16 and a roof 18 of the vehicle 12. The inflatable curtain 14 is inflatable from the stored position to a deployed position (shown in dashed lines at 14′) extending away from the roof 18 along the side structure 16. In the deployed position, the inflatable curtain 14 is positioned between the side structure 16 and any occupants of the vehicle 12.

The inflatable curtain 14 can be constructed of any suitable material, such as nylon (e.g., woven nylon 6-6 yarns). The inflatable curtain 14 may be uncoated, coated with a material, such as a gas impermeable urethane, or laminated with a material, such as a gas impermeable film. The inflatable curtain 14 thus may have a gas-tight or substantially gas-tight construction. Those skilled in the art will appreciate that alternative materials, such as polyester yarn, and alternatives coatings, such as silicone, may also be used to construct the inflatable curtain 14.

The apparatus 10 also includes an inflation fluid source in the form of an inflator 40. The inflator 40 is actuatable to provide inflation fluid for inflating the inflatable curtain 14. In the embodiment illustrated in FIG. 1, the inflator 40 is connected in fluid communication with the inflatable curtain 14 through a fill tube 42. Alternatively, the fill tube 42 could be omitted, in which case the inflator 40 could be connected directly to the inflatable curtain 14.

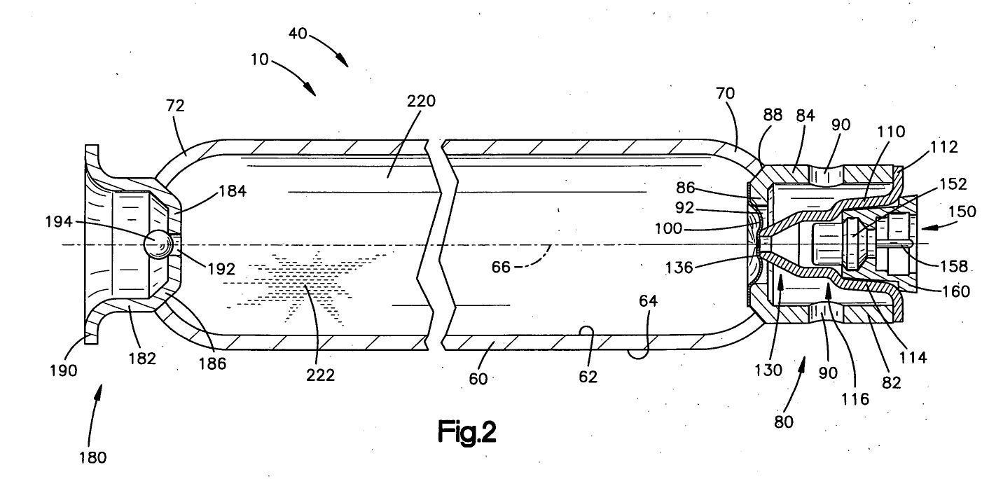

The configuration of the inflator 40 may vary. An example of the configuration of the inflator 40 is shown in FIG. 2. In the example of FIG. 2, the inflator 40 includes a body portion 60, a diffuser assembly 80, and a fill cap 180. The body portion 60 has an elongated cylindrical configuration and is constructed of a high strength material, such as tubular steel, aluminum, or other suitable metals or metal alloys. The body portion 60 includes a cylindrical inner surface 62 that defines an inside diameter of the body portion and an outer surface 64 that defines an outside diameter of the body portion. The inner and outer surfaces 62 and 64 are centered on a longitudinal axis 66 of the inflator 40. The body portion 60 has a length measured along the axis 66. The body portion 60 of the inflator 40 also has opposite first and second open ends 70 and 72, respectively. In the embodiment of FIG. 2, the ends 70 and 72 are swaged and thus have reduced diameters.

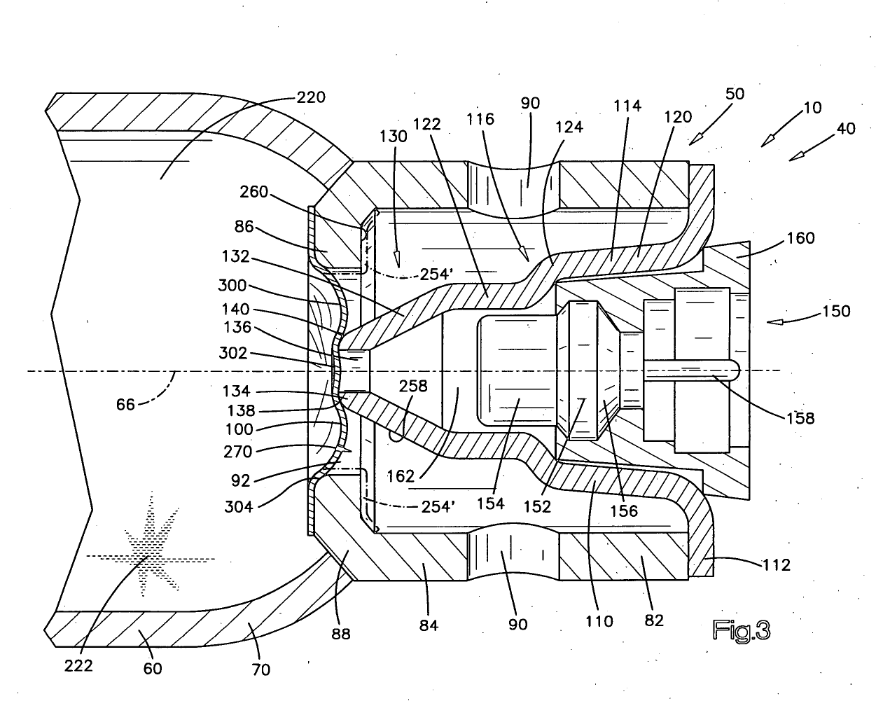

Referring to FIGS. 2 and 3, the diffuser assembly 80 is connected to the first open end 70 of the body portion 60. The diffuser assembly 80 includes a diffuser cap 82 that is constructed of a material similar or identical to the body portion 60, e.g., steel, aluminum, or other suitable metals or metal alloys. The diffuser cap 82 may be formed in any suitable manner, such as by stamping the diffuser cap from a single piece of material.

The diffuser cap 82 includes a cylindrical side wall 84 and an end wall 86 that intersect each other at an annular shoulder 88. The side wall 84 includes one or more radially spaced discharge ports 90. The inflator 40 thus comprises a radial flow diffuser configured to discharge inflation fluid from the diffuser cap 92 in directions radial with respect to the axis 66. The end wall 86 includes a central opening 92.

The diffuser assembly 80 also includes a rupturable closure member 100, such as a burst disk or rupture disk, constructed of a material that is generally strong and capable of withstanding relatively high pressure and stress, such as steel. The closure member 100 is secured to the end wall 86 of the diffuser cap 82 by known means (not shown), such as welding. When connected to the diffuser cap 82, the closure member 100 spans (extends across) and covers the opening 92.

The diffuser assembly 80 also includes a support 110 for helping to support the closure member 100. The support 110 is constructed of a material, such as steel, aluminum, or other suitable metals or metal alloys, that is generally strong and rigid. In one particular construction, the support 110 is stamped from a single piece of steel to the form shown in FIGS. 2 and 3.

The support 110 includes an annular flange portion 112 that is connected to a terminal end of the diffuser cap side wall 84 by known means, such as welding. The support 110 has a side wall 114 with an initiator receiving portion 116 configured to receive an initiator assembly 150. The initiator receiving portion 116 includes a tapered first portion 120 (FIG. 3), a cylindrical second portion 122 and a rounded shoulder portion 124 that joins the first and second portions.

The side wall 114 also includes a nozzle portion 130. The nozzle portion 130 has a tapered, frusto-conical focusing wall 132 that extends from the initiator receiving portion 116 and is tapered toward the axis 66. The nozzle portion 130 includes a terminal end wall 134 with a nozzle opening 136. In a stamped configuration of the support 110, the die used to stamp the support may also be configured to form (e.g., punch) the nozzle opening 136 in a single stamping operation. The end of the nozzle portion 130 has a rounded configuration that forms a radius 140 that extends between the focusing wall 132 and the end wall 134.

The initiator assembly 150 includes an initiator 152 and an initiator retainer 160. The initiator 152 may comprise a pyrotechnic device, such as a squib. The initiator 152 includes a cap portion 154 that contains a volume of pyrotechnic material (not shown), such as zirconium potassium perchlorate (ZPP). The initiator 152 also includes a support portion 156 and leads 158 through which an electrical current may be supplied to actuate the initiator by igniting the pyrotechnic material.

The initiator retainer 160 helps secure the initiator 152 in the initiator receiving portion 116 of the support 110. The initiator retainer 160 includes an inner surface configured to mate with the support portion 156 of the initiator 152. The initiator retainer 160 may be connected to the initiator 152 in a variety of manners. For example, a metal initiator retainer 160 may be crimped onto the initiator 152. As another example, the initiator 152 may be insert molded in a polymeric, elastomeric, or plastic initiator retainer 160 The initiator retainer 160 has an outer surface configured to engage the initiator receiving portion 116 of the support 110. The initiator retainer 160 is connected to the support 110 by means (not shown), such as welding, and thereby secures the initiator 152 to the support 110. When the initiator 152 is secured to the support 110, the cap portion 154 is positioned in an ignition chamber 162 defined by the initiator receiving portion 116 and nozzle portion 130.

Referring to FIG. 2, in the assembled condition of the inflator 40, the diffuser assembly 80 is aligned with the body portion 60 along the axis 66. The shoulder portion 88 of the diffuser cap 82 is positioned engaging the open end portion 70 of the body portion 60 and is connected to the open end portion by suitable means (not shown), such as welding.

The fill cap 180 is connected to the second open end 72 of the body portion 60. The fill cap 180 may be constructed of a material similar or identical to the body portion 60, e.g., steel, aluminum, or other suitable metals or metal alloys. The fill cap 180 may be formed in any suitable manner, such as by stamping the fill cap from a single piece of material.

The fill cap 180 includes a cylindrical side wall 182 and an end wall 184 joined by an annular shoulder 186. A terminal end portion 190 of the side wall 182 may have a flared or flanged configuration. The fill cap 180 also includes a fill passage 192 located centrally on the end wall 184. Means 194, such as a metal stop ball, may be secured to the fill cap 180 by means (not shown), such as welding, to block fluid flow through the fill passage 192.

The body portion 60, diffuser assembly 80, and fill cap 180 help define a chamber 220 for storing a volume of inflation fluid 222 under pressure. The volume of inflation fluid 222 stored in the chamber 220 may vary depending, for example, on the volume of the inflatable curtain 14 or the pressure at which the inflation fluid is stored. To achieve the desired volume of the chamber 220, the length of the body portion 60 may be altered while maintaining a nominal diameter. This allows the configuration of the diffuser assembly 80 and fill cap 180 to remain constant while tailoring the length of the chamber 220 to have the desired volume. Examples of this are set forth below in Tables 1 and 2:

TABLE 1
Chamber lengths for amounts of inflation fluid
stored at 42 MPa @ 22° C.

| Moles of | 30 mm Nominal | 35 mm Nominal | 40 mm Nominal |
|---|---|---|---|
| Inflation | Diameter (OD) | Diameter (OD) | Diameter (OD) |
| fluid | Length (mm) | Length (mm) | Length (mm) |
| 1.6 | 255 | 200 | 162 |
| 1.9 | 294 | 228 | 184 |
| 2.2 | 334 | 257 | 205 |
| 2.5 | 373 | 285 | 227 |
| 3.0 | 439 | 333 | 263 |
| 4.0 | 571 | 428 | 335 |
| 5.0 | 702 | 524 | 407 |
| 6.0 | 834 | 619 | 479 |

TABLE 2
Chamber lengths for amounts of inflation fluid
stored at 69 MPa @ 22° C.

| Moles of | 30 mm Nominal | 35 mm Nominal | 40 mm Nominal |
|---|---|---|---|
| Inflation | Diameter (OD) | Diameter (OD) | Diameter (OD) |
| fluid | Length (mm) | Length (mm) | Length (mm) |
| 1.6 | 197 | 160 | 135 |
| 1.9 | 223 | 180 | 150 |
| 2.2 | 250 | 199 | 164 |
| 2.5 | 277 | 218 | 179 |
| 3.0 | 321 | 251 | 203 |
| 4.0 | 410 | 315 | 252 |
| 5.0 | 499 | 379 | 301 |
| 6.0 | 589 | 444 | 349 |

According to the present invention, the inflation fluid 222 may be of any type suited to provide desired inflation performance characteristics. For example, the inflator 40 may be a stored gas inflator in which the inflation fluid 222 may comprise one or more gasses, such as helium, argon, nitrogen, and air, stored under pressure. As another example, the inflator 40 may be a heated gas inflator in which the inflation fluid 222 may comprise a fuel gas, an oxidizer gas, and, optionally, one or more inert gasses.

The inflation fluid 222, when pressurized in the chamber 220, deforms the closure member 100 against the end wall 134 and radius 140 of the nozzle portion 130, as shown in FIGS. 2-3. The closure member 100 blocks inflation fluid flow from the chamber 220 into the diffuser assembly 80 through the opening 92.

Referring to FIG. 1, upon sensing the occurrence of an event for which inflation of the inflatable curtain is desired, such as a side impact, a vehicle rollover, or both, a sensor 230 provides an actuation signal to the inflator 40 via lead wires 232. Referring to FIG. 2, the lead wires 232 provide the actuation signal to the leads 158 of the initiator 152. The initiator 152 is actuated in response to receiving the actuation signal.

When the initiator 152 is actuated, the pyrotechnic material in the cap 154 ignites, rupturing the cap and creating combustion products in the chamber 162. The combustion products may, for example, include a combination of heat and gasses. The tapered frusto-conical configuration of the nozzle portion 130 helps focus the combustion products on the closure member 100 through the nozzle opening 136. The combustion products act on the closure member 100, causing the closure member to rupture.

Upon rupture of the closure member 100, the inflation fluid 222 is released from the chamber 220 to flow through the discharge opening 92 and into the diffuser assembly 80. The inflation fluid is directed radially from the diffuser assembly 80 through the outlet openings 90 toward the inflatable curtain 14 via the fill tube 42 (FIG. 1). The inflatable curtain 14 inflates and deploys under the pressure of inflation fluid provided by the inflator 40 to the position illustrated at 14′ in FIG. 1.

There are several criteria used to measure the performance of the closure member 100. First, the closure member 100 must maintain its integrity in blocking fluid flow through the opening 92 throughout a wide temperature band, such as from −40° C. to +115° C. Also, actuation of the initiator 152 should cause the closure member 100 to open with a high degree of reliability and without fragmenting. Further, the closure member 100 should fully “wipe” (as defined below) during deployment. According to the present invention, the configuration and construction of the closure member 100 and support 110 are designed to help achieve these criteria.

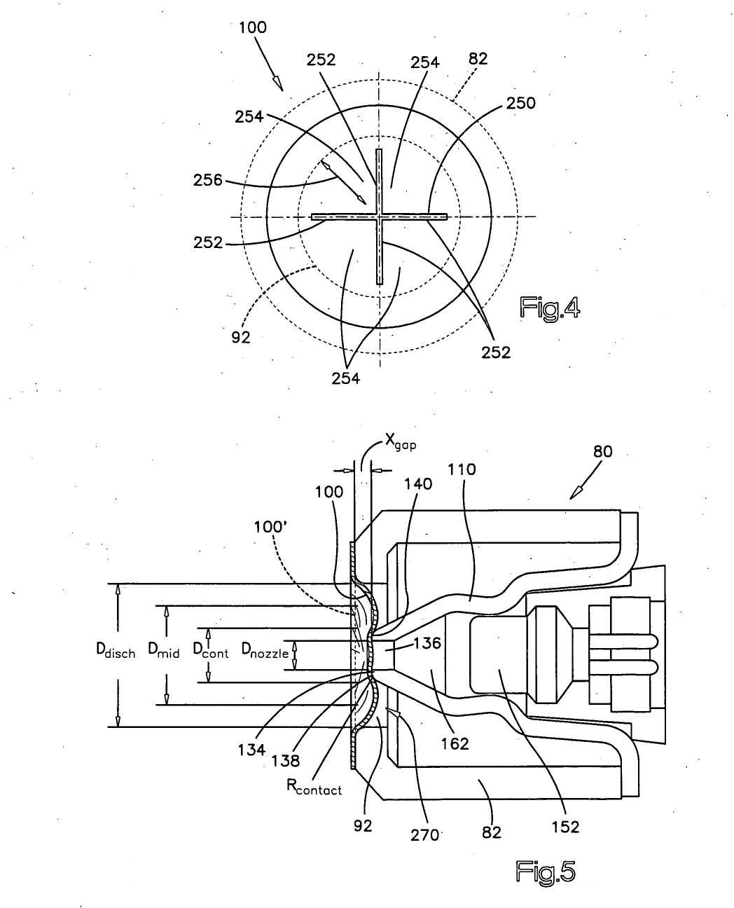

One manner in which to help achieve the desired criteria is through the design of the closure member 100. An example of the configuration of the closure member 100 is shown in FIG. 4. In this configuration, the closure member 100 has a metal (e.g., steel) construction and may have a thickness in the range of 0.20 mm-0.60 mm. Referring to FIG. 4, the closure member 100 has a circular, disk-shaped configuration with cross-shaped or cruciform score lines 250 centered on the disk. The score lines 250 may, for example, be in the range of 0.05 mm-0.15 mm deep.

The score lines 250 include four arms 252 that extend in directions with 90° between adjacent arms. The arms 252 help define petals 254 of the closure member 100. As indicated generally by the arrows identified at 256, the grain direction of the metal used to construct the closure member 100 bisects two sets of adjacent arms 252 and extends at an angle of about 45° relative to horizontal as viewed in FIG. 4.

The score lines 250 help define the path along which the closure member 100 tears or ruptures when acted on by the initiator 152. The score lines 250 cause the closure member 100 to tear uniformly and thereby help prevent the closure member 100 from fragmenting when ruptured. Upon rupture of the closure member 100, the petals 254 bend along lines that coincide generally with the periphery of the opening 92 of the diffuser cap 82 (see FIG. 3). The grain direction 256, selected to run in the direction described above, results in two of the petals 254 bending generally parallel to the grain direction and two of the petals bending generally perpendicular to the grain direction.

The configuration and construction of the support 110 and its relationship with the performance of the closure member 100 is described herein with reference to FIG. 5. FIG. 5 illustrates several dimensions and spatial relationships between various components of the diffuser assembly 80, particularly the closure member 100, support 110, and opening 92, that may have a bearing or impact on the performance of the closure member.

Referring to FIG. 5, the gap distance, X_{gap}, is the distance between the end 134 of the support 110 against which the closure member 100 rests when deflected by the pressure of inflation fluid and the non-deflected position of the closure member identified generally at 100′ in FIG. 5. The nozzle diameter, D_{nozzle}, is the diameter of the nozzle opening 136 in the support 110. The contact diameter, D_{cont}, is the outer diameter of the contact area between the support 100 and the closure member 100. The discharge diameter, D_{disch}, is the diameter of the discharge opening 92. The midpoint diameter, D_{mid}, is the diameter at the midpoint between the contact diameter D_{cont} and the discharge diameter D_{disch}. An annular passageway 270 of the diffuser assembly 80 is defined as the area between the discharge diameter D_{disch} and the contact diameter D_{cont}.

A contact portion 138 of the closure member 100 contacts the nozzle portion 130 at the end 134 of the support 110 and encircles the nozzle opening 136. The contact portion 138 is deformed by the pressure of inflation fluid into engagement with the nozzle portion 130 and conforms to the contour of the nozzle portion. As shown in FIG. 5, a contact radius R_{contact} of the closure member 100 is defined as the radius of curvature of the contact portion 138 that engages the end 134 of the support 110. The contact radius R_{contact} is thus defined by radius 140 at the end 134 of the support 110.

According to the present invention, to help improve performance of the closure member 100 in accordance with the criteria described above, the following design objectives are set forth:
1. The area of the passageway 270 should be as large as possible so as to promote the closure member 100 opening and wiping fully.
2. The sealing force between the closure member 100 and the support 110 should meet or exceed a threshold force.
3. The pressure in the initiator chamber 162 shouldn't be so excessive as to cause ejection of the initiator 152.
4. The stress and strain on the closure member 100 should, to the extent practical, be balanced (as described below) and not excessive or concentrated.

The area of the passageway A_{passageway} is related to the wiping action of the closure member 100. “Wiping” relates to the petals 254 sliding against an outer surface 258 of the support 100. As such, the term “wiping” is used to refer to the degree to which the petals 254 of the closure member 100 bend or deflect when the inflator 40 is actuated. “Fully wiped” petals 254 are those that deflect to lie against or substantially against the inflator structure, e.g., an inner surface 260 of the diffuser cap 82, and thus fully or substantially open the passageway 270 for discharge inflation fluid flow. Fully wiped petals 254 thus may be desirable because they provide the least restriction to inflation fluid flow. Petals fully wiped against the inner surface 260 of the diffuser cap 82 are shown in dashed lines at 254′ in FIG. 3.

In general, it has been found that as the area of the passageway 270 increases, the wiping action of the closure member 100 improves. In part, this is because, as the area of the passageway 270 increases, the moments acting on the petals 254 due to inflation fluid pressure increase, which helps bend and deflect the petals toward the fully wiped position. It is therefore desirable to increase the area of the passageway 270 of the inflator to help provide full wiping of the petals 254 of the closure member 100. According to the present invention, this is achieved through the implementation of the tapered, frusto-conical configuration of the side wall 132 of the nozzle portion 130.

Through testing and gathering of data, it was also determined that the strain on the closure member 100 should not exceed a threshold of 60% of rupture strain at the maximum temperature condition (115° C.). The strain on the closure member 100 also should be balanced between the contact diameter D_{cont} and the nozzle diameter D_{nozzle}, with the goal being to balance the stresses such that they differ by less than about 10-20%. Factors that affect the strain on the closure member 100 include the contact radius R_{contact}, gap distance X_{gap}, and closure member thickness.

Referring to FIG. 3, the closure member 100 being deformed into engagement with the support 110 under the fill pressure P_{fill} forms a ring-shaped portion 300 deformed or deflected into the discharge passageway 270, a ring-shaped portion 304 deformed or deflected around the end wall 86 of the diffuser cap 82, and a central domed portion 302 deformed or deflected about the nozzle portion 132 of the support 110. These deformed portions 300, 302, and 304 comprise areas where increased stress, i.e., stress risers, may occur in the closure member 100. Because the score lines 250 do not extend through the portion 304, the areas of primary concern in terms of stress risers are the portions 300 and 302.

It has been found that the primary factors that determine the stress at portions 300 and 302 are the contact radius R_{contact}, gap distance X_{gap}, and thickness of the closure member 100. Because the closure member 100 may typically be of a standard thickness, the contact radius R_{contact} and gap distance X_{gap} may be the factors most appropriate to adjust in order to help balance the stress between the portions 300 and 302. Therefore, the contact radius R_{contact}, gap distance X_{gap}, or both may be adjusted to help balance these stresses.

As mentioned above, efforts to balance stress in the closure member 100 and to increase the area of the discharge passageway 270 to improve flow and wiping may compete against each other in terms of forming the nozzle portion 130, particularly the angles of the side wall 132 and the size of the radius 140. On one hand, increasing wiping action and the area of the discharge passageway 270 may dictate a more sharp or tight radius 140. On the other hand, balancing the stress in the portions 300 and 302 of the closure member 100 may dictate a lesser radius.

Maintaining the appropriate sealing force helps ensure that actuation of the initiator 152 will rupture the closure member 100. The sealing force is a function of the gap distance X_{gap}, fill pressure P_{fill}, the thickness of the closure member 100 T_{closure}, the discharge diameter D_{disch}, and the contact area A_{contact} defined by the contact diameter D_{cont} and the nozzle diameter D_{nozzle}.

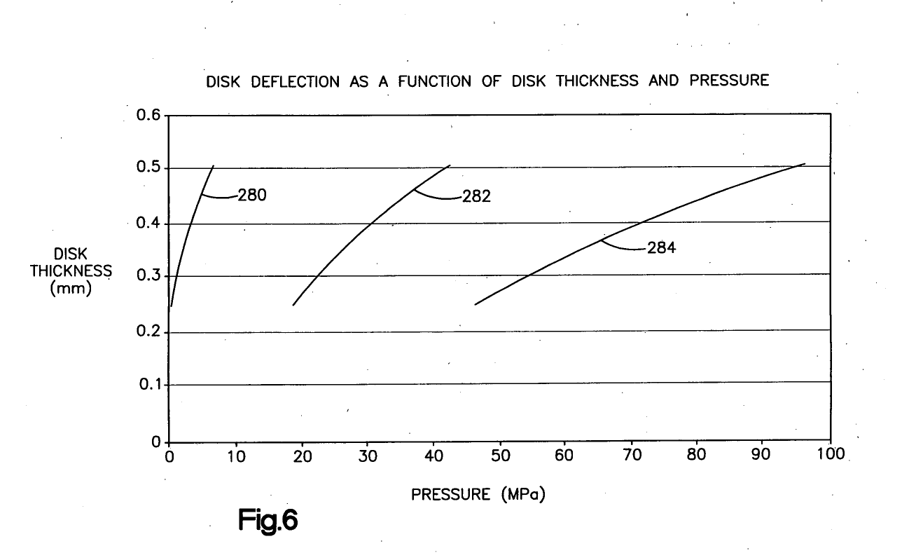

Through computer modeling and the gathering of empirical data, an equation relating closure member deflection to inflation fluid fill pressure, P_{fill}, and closure member thickness, T_{closure}, was developed as shown in Equation 1 as follows:
Deflection=0.2155P_{fill}^{-2.5969T}^{_{closure}}+1.4672^{-1.7369T}^{_{closure}};
where P_{fill} is measured in thousands of pounds per square inch (ksi) and T_{closure} is measured in millimeters. From this, the chart shown in FIG. 6 was developed. The chart of FIG. 6 illustrates closure member deflection as a function of closure member thickness and inflation fluid fill pressure. In FIG. 6, the line identified at 280 illustrates pressure-thickness combinations that result in 1.0 mm deflection, the line identified at 282 illustrates pressure-thickness combinations that result in 2.0 mm deflection, and the line identified at 284 illustrates pressure-thickness combinations that result in 3.0 mm deflection.

Knowing these relationships, the force exerted on the support 110 by the closure member 100 can be determined. For example, if the inflator 40 is configured such that the gap distance X_{gap} is 2.0 mm and the thickness T_{closure} of the closure member 100 is 0.4 mm, FIG. 6 shows that approximately 30 MPa of inflation fluid fill pressure will deflect the closure member so that it just contacts the support 100. Accordingly, any fill pressure above and beyond 30 MPa will cause the closure member 100 to exert a force on the support 110.

Referring to FIG. 5, the pressure on the support 100, Pₛᵤₚₚₒᵣₜ, can be calculated through the following equations:
Pₛᵤₚₚₒᵣₜ=Fₛᵤₚₚₒᵣₜ·A_{contact} Equation 2
where Fₛᵤₚₚₒᵣₜ is the force exerted on the support 110 by the closure member 100 when deflected by the inflation fluid and A_{contact} is the area of contact between the support 110 and the closure member 100. Based on the Geometry shown in FIG. 5, A_{contact} is calculated as shown in Equation 3 as follows:

$${A}_{contact} = {π ( \frac{{D}_{nozzle}}{2} + 0.707 {R}_{contact} )}^{2} - {π ( \frac{{D}_{nozzle}}{2} )}^{2}$$

Further computer modeling determined the following relationship:

$${F}_{support} = {F}_{total} \cdot \frac{{A}_{mid}}{{A}_{disch}} \qquad Equation 4$$

and:
Fₜₒₜₐₗ=P_{fill}·A_{disch} Equation 5
and, therefore:
Fₛᵤₚₚₒᵣₜ=P_{fill}·A_{mid} Equation 6
where:

$${A}_{mid} = {π ( \frac{{D}_{disch}}{2} - ( \frac{{D}_{nozzle}}{2} + 0.707 {R}_{contact } ) )}^{2} \qquad Equation 7$$

From the above, it will be appreciated that the support force Fₛᵤₚₚₒᵣₜ or pressure Pₛᵤₚₚₒᵣₜ required to achieve the desired sealing force can be tailored by adjusting the characteristics of the inflator 40, such as the fill pressure P_{fill}, the discharge diameter D_{disch}, the nozzle diameter D_{nozzle}, and the contact radius R_{contact}.

The pressure generated the ignition chamber 162 when the initiator 152 is actuated is referred to herein as the “initiator pressure.” For an initiator 152 having a given configuration, the initiator pressure is related to the volume of the ignition chamber 162 (V_{chamber}) and the area of the nozzle opening 136 as defined by the nozzle diameter (D_{nozzle}). The initiator pressure is also affects whether the initiator 152 ejects from the support 110 when actuated. Through computer modeling and the gathering of empirical data, it has been determined that, for any particular configuration of the initiator 152, there are acceptable combinations of chamber volume and nozzle area in which initiator ejection is unlikely to occur.

Improved configurations for the inflator 40 were determined by balancing the factors described above to help both improve the performance characteristics and achieve the design objectives for the inflator. To help improve the configurations, nozzle portion 130 with a tapered, frusto-conical configuration was designed to achieve a balance between an increased area of the passageway 270 to promote wiping and a chamber volume V_{chamber} sufficient to help prevent ejection of the initiator 152. Also, the nozzle diameter D_{nozzle} and contact radius R_{contact} were configured to achieve a balance between stress/strain distribution on the closure member 100 and providing a sufficient sealing force between the closure member and the support 110.

Based on the above, improved configurations for the following two examples of inflator families were determined: a standard pressure inflator family having a fill pressure of 42 MPa and a high pressure inflator family having a fill pressure of 69 MPa. For the standard pressure inflator family, the following configurations were determined to provide performance characteristics that help achieve the design objectives:
D_{disch}=16.0 mm
D_{cont}=4.0 mm
R_{contact}=1.9 mm
X_{gap}=2.0 mm
D_{nozzle}=3.0 mm
V_{chamber}=250 mm³

For the high pressure inflator family, the following configurations were determined to provide performance characteristics that help achieve the design objectives:
D_{disch}=16.0 mm
D_{cont}=5.0 mm
R_{contact}=1.5 mm
X_{gap}=2.0 mm
D_{nozzle}=4.0 mm
V_{chamber}=250 mm³

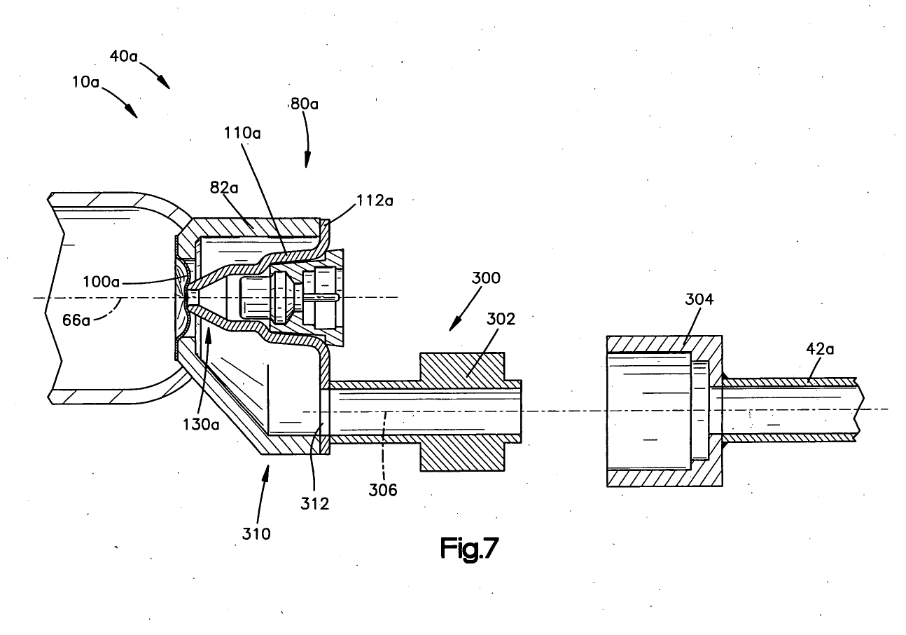

A second embodiment of the present invention is illustrated in FIG. 7. The second embodiment of the invention is similar to the first embodiment of the invention illustrated in FIGS. 1-5. Accordingly, numerals similar to those of FIGS. 1-5 will be utilized in FIG. 7 to identify similar components, the suffix letter “a” being associated with the numerals of FIG. 7 to avoid confusion. The embodiment of FIG. 7 is similar to the embodiment of FIGS. 1-5, except the apparatus 10a of FIG. 7 comprises an inflator 40a that includes an axial flow diffuser as opposed to the radial flow diffuser of the embodiment of FIGS. 1-5.

The inflator 40a of the second embodiment may be similar or identical to the inflator of the first embodiment, with the exception of those parts modified to configure the inflator for axial discharge flow. Particularly, the nozzle portion 130a of the support 110a, the closure member 100a, and the interface between the closure member and the diffuser cap 82a may be identical (as shown in FIG. 7) or similar to that of the second embodiment. The inflator 40a of the second embodiment may thus incorporate the features described in regard to the first embodiment in order to help improve its performance characteristics and achieve the design objectives set forth above.

As shown in FIG. 7, the diffuser cap 82a and support 110a are configured to receive an axial discharge connector assembly 300 for connecting the inflator to the fill tube 42a. The connector assembly 300 has an axis 306 that extends generally parallel to the axis 66a of the inflator 40a. As shown in FIG. 7, the connector assembly 300 may include a fitting piece 302 connectable with a corresponding fitting piece 304 associated with the fill tube 42a. The connector assembly 300 may thus provide fluid communication between the diffuser assembly 80a and the fill tube 42a.

To accommodate the connector assembly 300, the diffuser cap 82a has a discharge portion 310 radially offset from the axis 66a. The flange portion 112a of the support 110a is configured to cover the discharge portion 310 and includes an opening 312 to which the fitting piece 302 is connectable by known means, such as welding. Connecting the inflator 40a to the fill tube 42a via the connector assembly 300 places the axes 66a and 306 generally parallel to each other and spaced from or offset from each other. The inflator 40a and fill tube 42a are thus placed in an axially arranged configuration. This may, for example, allow for installing the apparatus 10a in a vehicle (not shown) having architecture that is better suited for an axially aligned configuration.

From the above description of the invention, those skilled in the art will perceive applications, improvements, changes and modifications to the present invention. Such applications, improvements, changes and modifications within the skill of the art are intended to be covered by the appended claims.

Having described the invention, we claim the following:

1. An inflator for inflating an inflatable vehicle occupant protection device, said inflator comprising:
a chamber for storing inflation fluid under pressure;
a first member having an inner perimeter defining an opening for discharging said inflation fluid;
a rupturable closure member extending across said opening, said rupturable closure member being for blocking inflation fluid flow though said opening;
a second member supporting a central portion of said rupturable closure member against the pressure of said inflation fluid in said chamber;
a passageway defined by an outer perimeter of said second member and the inner perimeter of said first member, said inflation fluid flowing through said passageway to the inflatable vehicle occupant protection device; and
an initiator for rupturing said rupturable closure member and forming petals of the closure member that deflect into said passageway, said petals sliding along an outer surface of said second member while deflecting into said passageway;
said outer surface of said second member being configured not to inhibit movement of the petals of the closure member into full engagement with an inner surface of said first member due to the fluid pressure acting on said closure member.

2. The inflator recited in claim 1, wherein said rupturable closure member engages terminal end portions of said first and second members and is curved in cross section due to the fluid under pressure, said terminal ends of said first and second members having curved configurations to avoid stress risers in said rupturable closure member.

3. The inflator recited in claim 2, wherein said terminal end portions of said first and second members are configured to help distribute stresses on the closure member.

4. The inflator recited in claim 1, wherein said first member comprises a diffuser member of said inflator.

5. The inflator recited in claim 1, wherein said second member comprises a support member adapted to direct combustion products of said initiator toward said closure member to rupture said closure member.

6. The inflator recited in claim 1, wherein said second member has a portion with a frusto-conical configuration that helps define the area of said passageway.

7. An inflator for inflating an inflatable vehicle occupant protection device, said inflator comprising:
a chamber for storing inflation fluid under pressure;
a first member defining an opening for discharging said inflation fluid;
a rupturable closure member extending across said opening, said rupturable closure member being for blocking inflation fluid flow though said opening; and
a second member supporting a central portion of said rupturable closure member against the pressure of said inflation fluid in said chamber, said rupturable closure member engaging terminal end portions of said first and second members and being curved in cross section due to the fluid under pressure;
said terminal end portions of said first and second members having curved configuration to avoid stress risers in said rupturable closure member.

8. The inflator recited in claim 7, further comprising:
a passageway defined by an outer perimeter of said second member and an inner perimeter of said first member, said inflation fluid flowing through said passageway to the inflatable vehicle occupant protection device; and
an initiator for rupturing said rupturable closure member and forming petals of the closure member that deflect into said passageway;
an outer surface of said second member being configured to not inhibit movement of the petals of the closure member into full engagement with an inner surface of said first member due to the fluid pressure acting on said closure member.

9. An inflator for inflating an inflatable vehicle occupant protection device, said inflator comprising:
structure defining a chamber for storing a volume of inflation fluid under pressure, said chamber comprising an opening for discharging said inflation fluid;
a rupturable closure member for blocking inflation fluid flow through said opening; and
a support for supporting said closure member against the pressure of said inflation fluid in said chamber, said support comprising:
a terminal end portion for engaging said closure member, said terminal end portion having a central opening across which said closure member extends; and
a frusto-conical side wall terminating with said end portion.

10. The inflator recited in claim 9, wherein said closure member petals when ruptured, said frusto-conical side wall being configured to increase the area of said passageway to promote full wiping of said petals.

11. The inflator recited in claim 9, wherein said closure member has a first annular portion deformed against said structure, a second annular portion deformed against said support, and a third annular portion between said first and second annular portions deformed into said opening when inflation fluid is stored under pressure in said chamber, said support being configured to help balance stresses between said first, second, and third annular portions of said closure member.
